(19) United States
(12) Patent Application Publication
(10) Pub. No.: US 2021/0125779 A1
(43) Pub. Date: Apr. 29, 2021

(54) METHOD FOR MAKING THIN-FILM INDUCTOR

(71) Applicant: Ralec Electronic Corporation, Kaohsiung (TW)

(72) Inventors: Tim WANG, Kaohsiung (TW); Chia-Cheng CHENG, Kaohsiung (TW)

(21) Appl. No.: 16/794,664

(22) Filed: Feb. 19, 2020

(30) Foreign Application Priority Data
Oct. 29, 2019 (TW) 108139061

(51) Int. Cl. H01F 41/04; H01F 41/076

(52) U.S. Cl. CPC H01F 41/042; H01F 41/076

(57) ABSTRACT

A method for making a thin-film inductor includes the steps of: a) forming an array of coil units from an electrically conductive substrate, b) introducing a magnetic material into mold cavities of a mold unit, c) disposing each of the coil units on the magnetic material in a respective one of the mold cavities, d) introducing additional magnetic material into the mold cavities to completely cover the coil units, e) molding the magnetic material and the coil units in the mold unit to form semi-products, and f) forming, on each of the semi-products, two terminal electrodes and electrically connecting the terminal electrodes to the coil unit so as to obtain the thin-film inductors.

### CROSS-REFERENCE TO RELATED APPLICATION

This application claims priority of Taiwanese Invention Patent Application No. 108139061, filed on Oct. 29, 2019.

### FIELD

This disclosure relates to a method for making a thin-film inductor.

### BACKGROUND

With the advancement of semiconductor technology, it has become a trend to develop lightweight and thin electronic devices. To meet such requirements, various miniaturized passive components (e.g., resistors, capacitors, or inductors) need to be manufactured in a simplified manner, and then precisely installed in the electronic devices, so as to effectively increase production efficiency of the electronic devices.

For example, a mini molding choke is a type of integrally-formed inductor which is generally made by first coiling a wire to form a coil circuit, and then packaging the coil circuit to obtain a final product. However, such conventional method has disadvantages, such as having a low production efficiency and difficulty in miniaturizing the mini molding choke.

### SUMMARY

Therefore, an object of the disclosure is to provide a method for making a thin-film inductor that can alleviate or eliminate at least one of the drawbacks of the prior art.

According to the disclosure, the method for making the thin-film inductor includes the steps of:

a) forming a plurality of coil units arranged in an array from an electrically conductive substrate;

b) introducing a magnetic material into mold cavities of a mold unit, the mold cavities being arranged corresponding in position to the coil units;

c) separating the coil units, and then disposing each of the coil units on the magnetic material in a respective one of the mold cavities;

d) introducing additional magnetic material into the mold cavities to completely cover the coil units;

e) molding the magnetic material and the coil units in the mold unit, so as to form a plurality of semi-products, each of the semi-products including a respective one of the coil units and a magnetic body of the magnetic material enclosing the coil unit; and

f) forming, on each of the semi-products, two terminal electrodes and electrically connecting the terminal electrodes to the coil unit, so as to obtain a plurality of the thin-film inductors.

### BRIEF DESCRIPTION OF THE DRAWINGS

Other features and advantages of the disclosure will become apparent in the following detailed description of the embodiment with reference to the accompanying drawings, in which:

FIG. 1 is a fragmentary schematic top view illustrating step a) of an embodiment of a method for making a thin-film inductor according to the disclosure;

FIG. 2 is a schematic sectional view illustrating step b) of the embodiment;

FIG. 3 is a schematic sectional view illustrating step c) of the embodiment;

FIG. 4 is a schematic sectional view illustrating step d) of the embodiment;

FIG. 5 is a schematic sectional view illustrating step e) of the embodiment; and

FIG. 6 is a schematic sectional view illustrating step f) of the embodiment.

### DETAILED DESCRIPTION

Before the disclosure is described in greater detail, it should be noted that where considered appropriate, reference numerals have been repeated among the figures to indicate corresponding or analogous elements, which may optionally have similar characteristics.

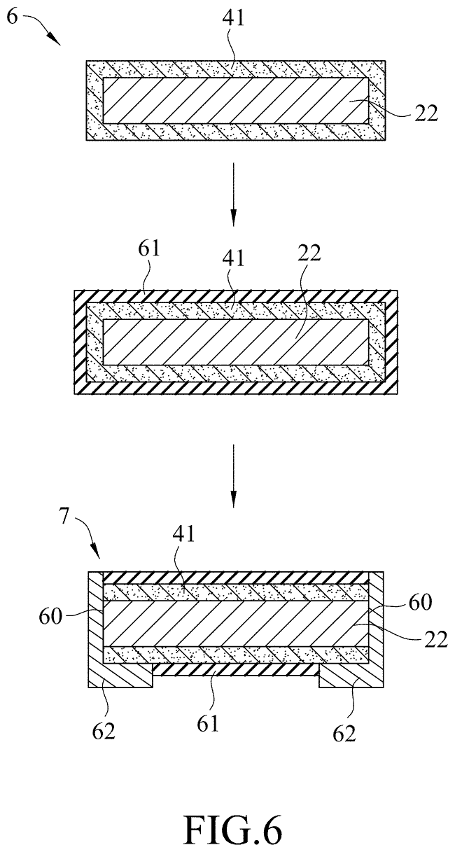

A method for making a thin-film inductor 7 (see FIG. 6) according to the disclosure includes at least the following steps a) to f).

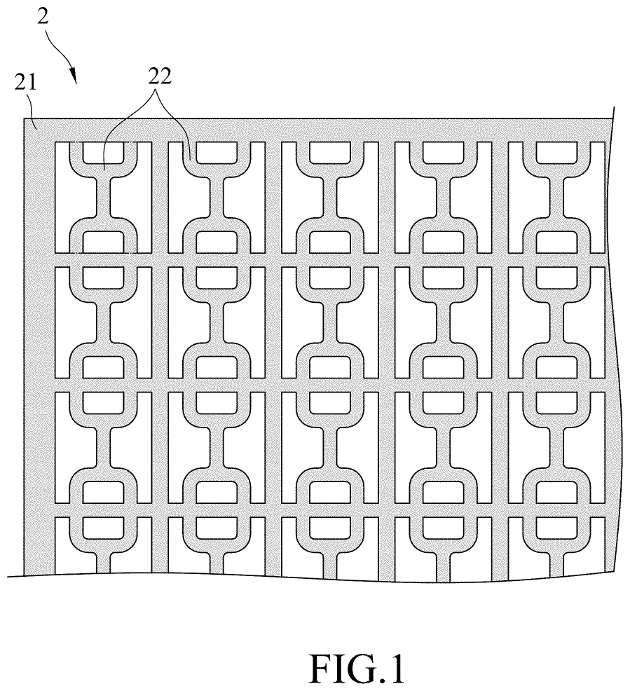

Referring to FIG. 1, in step a), a plurality of coil units 22 arranged in an array are formed from an electrically conductive substrate 21. That is, the electrically conductive substrate 21 is formed with the coil units 22 using an etching process (such as photolithography). Alternatively, the coil units 22 may be formed by other processes, e.g., a stamping process and a laser-cutting process. In this embodiment, the electrically conductive substrate 21 is made of copper, but is not limited thereto.

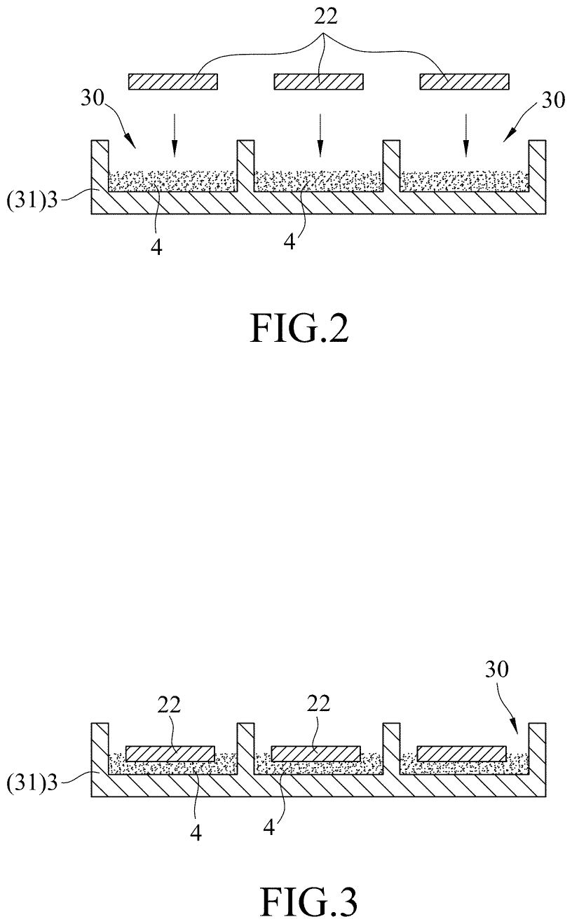

Each of the coil unit 22 may include coil patterns that are formed of a plurality of plating layers. The configuration (including arrangement, shape, width and/or the thickness) of the coil units 22 may be modified according to practical requirements and are well-known to those skilled in the art, and therefore the detailed description thereof is omitted herein for the sake of brevity. Referring to FIG. 2, in step b), a magnetic material 4 is introduced into mold cavities 30 of a mold unit 3. The mold unit 3 includes a first mold 31 and a second mold 32 (shown in FIG. 5) that cooperatively define the mold cavities 30. The mold cavities 30 are arranged corresponding in position to the coil units 22.

Referring to FIG. 3, in step c), the coil units 22 are separated, e.g., by punching connection regions between the coil units 22 and the electrically conductive substrate 21. Each of the separated coil units 22 is then disposed onto the magnetic material 4 in a respective one of the mold cavities 30. A bottom region of each of the coil unit 22 is immersed in the magnetic material 4, and a top region of each of the coil unit 22 is exposed from the magnetic material 4.

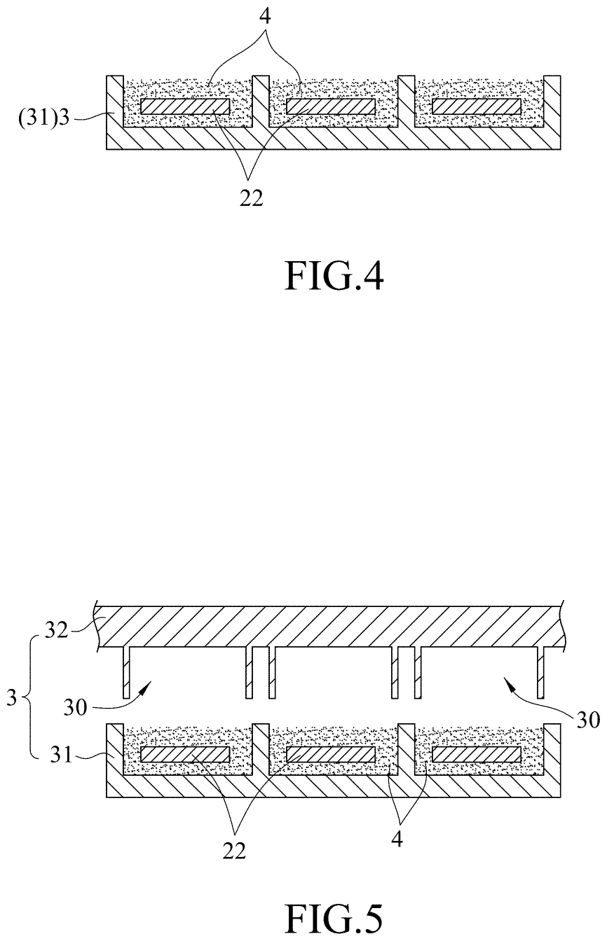

Referring to FIG. 4, in step d), additional magnetic material 4 is introduced into the mold cavities 30 to completely cover the coil units 22. The magnetic material 4 used in both steps b) and d) may be in a powder form, but is not limited thereto.

It should be noted that the amount and the type of the magnetic material 4 added in steps b) and d) may be adjusted depending on a desirable size (such as thickness) of the thin-film inductor 7 to be made.

Referring to FIG. 5, in step e), the magnetic material 4 and the coil units 22 are molded in the mold unit 3 to form a plurality of semi-products 6. Specifically, step e) in conducted by mating and pressing the first mold 31 and the second mold 32 that is in sealed engagement with the first mold 31. During the molding process, the magnetic material 4 in each cavity 30 is solidified to form a magnetic body 41 of the magnetic material 4 enclosing the coil unit 22 (see FIG. 6). That is, each of the semi-products 6 includes a respective one of the coil units 22 and the magnetic body 41 of the magnetic material 4. Conditions of the molding process may be adjusted according to practical needs. For example, the molding process is conducted under a pressure ranging from 5 MPa to 100 MPa and at a temperature ranging from 100° C. to 250° C.

Referring to FIG. 6, in step f), on each of the semi-products 6, two terminal electrodes 62 are formed and electrically connected to the coil unit 22, so as to obtain a plurality of the thin-film inductors 7, which are expected to have increased inductance.

The method may further include, after step e) and before step f), steps g) h). To be specific, in step g), for each of the semi-products 6, an insulating layer which covers the magnetic body 41 is formed. Subsequently, in step h), for each of the semi-products 6, a portion of the insulating layer 61 and a portion of the magnetic body 41 are removed to expose opposite two terminal ends 60 of the coil unit 22. The two terminal electrodes 61 are then formed on the two terminal ends 60 in step f).

In sum, by forming the coil units 22 arranged in an array and molding the coil units 22 enclosed by the magnetic material 4 in a respective one of the mold cavities 30 of the mold unit 3, the thin-film inductor 7 having a miniaturized size made by the method according to the disclosure may be produced in a batch manner, so as to increase production efficiency.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for making a thin-film inductor, comprising the steps of:
a) forming a plurality of coil units arranged in an array from an electrically conductive substrate;
b) introducing a magnetic material into mold cavities of a mold unit, the mold cavities being arranged corresponding in position to the coil units;
c) separating the coil units, and then disposing each of the coil units on the magnetic material in a respective one of the mold cavities;
d) introducing additional magnetic material into the mold cavities to completely cover the coil units;
e) molding the magnetic material and the coil units in the mold unit, so as to form a plurality of semi-products, each of the semi-products including a respective one of the coil units and a magnetic body of the magnetic material enclosing the coil unit; and
f) forming, on each of the semi-products, two terminal electrodes and electrically connecting the terminal electrodes to the coil unit, so as to obtain a plurality of the thin-film inductors.

2. The method according to claim 1, wherein in step a), the coil units are formed by one of a stamping process, a laser cutting process, and an etching process.

3. The method according to claim 1, wherein the magnetic material used in steps b) and d) is in a powder form.

4. The method according to claim 1, further comprising, after step e) and before step f), step g) of, for each of the semi-products, forming an insulating layer covering the magnetic body.

5. The method according to claim 4, further comprising, after step g), step h) of, for each of the semi-products, removing a portion of the insulating layer and a portion of the magnetic body to expose opposite two terminal ends of the coil unit, and then forming the two terminal electrodes on the two terminal ends in step (f).
